(19) United States
(12) Patent Application Publication
(10) Pub. No.: US 2008/0047498 A1
(43) Pub. Date: Feb. 28, 2008

(54) Water heating device for use with portable power supplies and methods related thereto

(76) Inventors: Thomas J. Hollyday, Weston, MA (US); David H. Helinek, Framingham, MA (US)

Correspondence Address: EDWARDS ANGELL PALMER & DODGE LLP, P.O. BOX 55874, BOSTON, MA, 02205, US

(21) Appl. No.: 11/879,220

(22) Filed: Jul. 16, 2007

Related U.S. Application Data
(60) Provisional application No. 60/831,054, filed on Jul. 14, 2006.

(51) Int. Cl. A01K 7/00; H05B 3/78

(52) U.S. Cl. 119/73; 392/497

(57) ABSTRACT

Featured is a device particularly suitable for heating water in a container, such as a pail or bird bath, so as to maintain a source of drinking water for domesticated animals, wild animals and livestock. A water heating device according to the present invention includes a housing, a heat generating mechanism that is disposed within the housing and electrically coupled to a power supply and a mechanism that thermally couples the heat generating mechanism and the housing so that at least some of the generated heat energy is coupled to the housing.

This application claims the benefit of U.S. Provisional Application Ser. No. 60/831,054 filed Jul. 14, 2006, the teachings of which are incorporated herein by reference.

### FIELD OF INVENTION

The present invention relates to waterers or watering devices that supply drinking water to animals, such as livestock, pets and wild animals (e.g., birds) and methods related thereto, more particularly to mechanisms and devices for heating the water in the watering devices during freezing (e.g., sub-zero) conditions and more specifically, to heating mechanisms or devices configured for use with a portable power source.

### BACKGROUND OF THE INVENTION

All animals, including pets, livestock and in the wild, require water for survival and to assist in the converting of solid feed or food into useable products for providing energy to the animal. Each of the different animal types typically are supplied water in different types of watering vessels, for example, bird baths, troughs, pet dishes and drinking buckets. These watering vessels can be located out doors or in unheated structures (e.g., horse barn), so the water therein is subject to freezing when the ambient air temperature drops below the freezing temperature of the liquid. Over time, a number of techniques have been developed or relied upon to prevent the water from freezing in these watering vessels.

One technique involves having an animal caretaker make periodic visits or trips to the watering vessel to break up any ice layer that may have formed so that the animal can access the liquid underneath the layer of ice as well as relying on the animal's ability to break through the ice layer, for example with the nose of a horse or a cow. Alternatively, or in addition to the breaking up of the ice layer, the animal caretaker may add warm water to the watering vessel in an attempt to raise the bulk temperature of the water and forestall the formation of an ice layer on the surface of the water. These techniques are very labor intensive and are not practical for all types of animal watering situations such as for example a remotely located waterer for wild animals.

Another technique is reported in U.S. Pat. No. 3,306,263 that describes a watering system for livestock. In this system the water is not heated in the watering bowl. Instead, water is continuously circulated between the watering bowl and a pan located below the frost line by means of an electric pump. Thus, a source of water having a temperature above freezing is continuously being added to the watering bowl. Such a system, however, is not practical for remotely located waters for wild animals and is not practical application for portable waterers.

According to yet another technique, a source of heat energy is disposed in close proximity to the waterer or watering vessel to heat the water directly within the watering vessel or heat the water indirectly by heating the watering vessel or a part thereof. The below identified patents report such applications, which also are more particularly described below. The below described systems/waterers/watering vessels are not practical for remote location applications because they generally require access to a source of AC electricity. In addition, AC electrical power lines would have to be run from the generation source or power distribution box (e.g., fuse box) to the water heating element(s), the installation of which is subject to building codes and regulations. Although some of the below described waterers/watering vessels purport to be portable, the heating element(s) therefore require a source of AC power and thus AC electrical power lines must be routed to the waterer/watering vessel. In addition to the limitations imposed by the type of electrical power, the below described patents are specific to the type of animal waterer/watering vessel.

There is reported in U.S. Pat. No. 5,345,063 a heated water bowl that is configured with a removable heating element that is proximate the bottom of the bowl. The specific source of electric power for the heating element is not described, other than referring to a conventional electric cord and illustrating a cord that would be plugged into a conventional household outlet. In other words, AC electrical power is provided to the heating element.

There is reported in U.S. Pat. No. 5,005,524 a watering dish with heating element. The heating element is located beneath the bottom of the bowl cavity that receives fluids and the like. Although the specific electric power source is not described, the heating element is described as a 500/1000 watt service element, which power levels are only reasonably attainable from an AC power source.

There is reported in U.S. Pat. No. 4,908,501 a heated inner container of an animal watering vessel. Specifically, the animal watering vessel consists of an exterior rubber container and an interior rubber container nested within the exterior container. An electric self-regulating heating cable is wrapped around the interior container and is in contact therewith. This heating cable operates on an electric current of 120 volts AC and provides 3 watts heat output per foot of cable.

There is reported in U.S. Pat. No. 4,883,022 a heated livestock waterer with a basin having water supply ports. The waterer consists of an insulated surround that receives a water container therein with float valve member. The heating elements extend into the water container and are located in the lower portion of this container. The specific source of power for the heating elements is not described other than that the heating elements are of well known technology.

There is reported in U.S. Pat. No. 4,640,226 a bird watering apparatus with heating elements. The heating element is spirally wound and in contact with the bottom surface of the inner wall namely the bottom of the bird bath. It also is described therein that a 115 AC electric source is the power source for the heating elements.

There is reported in U.S. Pat. No. 4,492,853 a heating device including a bowl with a stand and a flat central base with an affixed heating element. The heating element is referred to as being of a known type, however, from the described use the heating element would be powered from household AC current/voltage.

There is reported in U.S. Pat. No. 3,820,508 the heating of water for a horse in an inner bucket within a support bucket. The inner bucket preferably is a twenty quart galvanized bucket that is heated by a wire heating element that is formed about the circumference of the removable bucket and along a portion of the length inner bucket. It is also provided that the wire heating element preferably extends along only the central portion since this will provide sufficient heat to prevent the water from freezing without the water becoming to warm. The wire heating element receives electricity from a transformer that is connected to a 110 voltage AC source. The transformer reduces the voltage and current to a level that will not electrocute a horse.

There is reported in U.S. Pat. No. 3,648,659 a bird bath having heating element(s). The heating element(s) of the heating unit is powered by electricity. Although the specific source of electrical power is not identified, it is provided that a male end of a plug of a suitable electric cord is plugged into a receptacle of the heating unit so that electric current is supplied to the heating elements. As such, one concludes that the heating element(s) are AC powered.

There is reported in U.S. Pat. No. 3,324,834 a heated waterer with pan having a slot that allows liquid to enter the drinking bowl. The heating element and its thermostat is located in a reservoir and an electric cord supplies electric current to the heating element. The water from the water supply fills the reservoir such that it overflows into a float bowl and thence passes through the slot in the pan so as to be available for drinking.

There is reported in U.S. Pat. No. 2,590,266 a heated waterer for hogs and other stock with a grid within the bowl. An electric heating coil or other heater of any suitable form is disposed in the recess located at the bottom of the reservoir. The heating coil is supplied with electricity by flexible wires that are connected to a suitable source of electric current.

There is reported in U.S. Pat. No. 2,479,355 a heated watering device for livestock. The livestock watering device is a drinking cup and two electric heaters, one heater for the drinking cup and another heater for the water supply line. The electric heater for the drinking cup is clamped to the bottom of the cup by means of a plate. Beyond providing that two electrically insulated supply conductors provide power to the heaters, there is no other discussion regarding the source of electric power. However, the cup heater is indicated as being of the type described in U.S. Pat. No. 2,112,729 and that the heater can have a capacity of 170 watts. The power output is of the type associated with AC power applications.

There is reported in U.S. Pat. No. 2,452,305 a heated poultry (e.g., hens) drinking fountain with a water flow slot. The fountain heater (see FIG. 5 thereof) comprises a housing that is lined with a heat-insulating material, the upper edge portion of which forms snuggly around the rim of the container holding the water therein. The heating element is located within the housing and can consist of a light bulb or other enclosed types of compacting heating.

There is reported in U.S. Pat. No. 854,647 a warmed poultry water fountain with a float having cavities with holes. The described heat source is a small alcohol lamp or the like.

It thus would be desirable to provide a new apparatus or device for heating at least some of the water in a watering vessel, when the watering vessel is exposed to freezing or sub-zero temperature conditions, so as to provide a source of drinking water for animals. It would be particularly desirable to provide such an apparatus/device that could accomplish such heating with a portable power source that is separate from or integrated with such an apparatus or device. It also would be desirable to provide such an apparatus/device that is easily adaptable for use with any of a number of watering vessels including those for different animals or types of animals particularly in comparison to prior art devices. Such an apparatus/device preferably would be simple in construction and less costly than prior art devices and such methods would not require highly skilled users to utilize the device.

### SUMMARY OF THE INVENTION

The present invention features a device for heating a fluid, such as water, so as to provide a liquid source of the fluid within a container using a portable power supply even when the ambient conditions are such as to lead to the freezing of the fluid. Such a heating device is particularly advantageous for heating the water in the waterer for animals including birds, livestock such as horses and wild animals so as to provide a supply of liquid water for drinking even when the ambient temperature of the air is such as to cause the water to freeze. The container or waterer holding the fluid/drinking water can be any of a number of containers known to those skilled in the art including, but not limited to a pail, and generally being characterized as having, but not limited to, a capacity of one quart, one gallon or 5 gallons. Such a heating device also is adaptable for use in combination with other types of water heating devices such as a well known solar water heating device for wild birds. Also featured is a device for use in combination with a power supply, a system embodying a fluid heating device and portable power supply as well as method for providing a supply of drinking fluid for consumption by domesticated animals, wild animals as well as livestock. Such a heating device, system and method advantageously allows a user to locate the waterer or container at a location best suited for access by the animal while minimizing, the risk of shock or injury to the animal by the portable power supply.

A water/fluid heating device according to one aspect of the present invention includes a housing, a heat generating mechanism that is disposed within the housing and electrically coupled to a portable power supply and a mechanism that thermally couples the heat generating mechanism and the housing so that at least some of the generated heat energy is coupled to the housing. The housing is configured and arranged so as to be immersible in fluid or water within the container/waterer and so that at least a portion of the heat energy being thermally coupled to the housing is dissipated to the fluid/water. Also, the heat generating mechanism is configured and arranged so the heat energy being dissipated to the fluid is sufficient to maintain a liquid supply of a least a portion of the fluid/water within the container/waterer for a predetermined time.

According to a second aspect of the present invention, such a water/fluid heating device is further configured so as to include a control mechanism that is responsive to water temperature, the temperature of the heating device and/or ambient temperature to selectively control the heat generating mechanism and thereby selectively control the generation of heat energy so that the temperature of the fluid or water is at least maintained above a predetermined temperature. In this way, heat generation occurs only where and as needed, whereby the power producing life of the power supply is extendable. In an exemplary illustrative embodiment, such a control mechanism is a temperature control switch, as is known to those skilled in the art that selectively controls the flow of electricity through the resistive element comprising the heat generating mechanism.

The heat generating mechanism and the portable power supply are generally configured and arranged so that a liquid supply of the fluid/water is provided by the heat energy being dissipated from the housing and so as to maintain this liquid supply of fluid/water for a predetermined time, for example, for a period of four or more hours. In specific embodiments, the heat generating mechanism is a resistive element having a resistivity in the range of from about 6 to 70 ohms, more particularly a resistivity in the range of from about 12 to 30 ohms and more specifically a resistivity of one of 18 ohms or 27 ohms.

A portable power supply according to the present invention, in its broadest aspects, is generally capable of providing a desired or predetermined current output (e.g., about 0.5 amperes) at the minimum ambient temperature for operation of the fluid-heating device. In exemplary embodiments, the minimum ambient temperature is at or above 10° F. or in the range of from about 10° F. to about 15° F. In other exemplary embodiments, the portable power supply is a battery having a nominal output voltage in the range of from about 12 to 15 VDC and a power capacity in the range of from about 4 AH to about 17 AH. The portable power supply also is adaptable so as to further include a charging mechanism, such as a trickle charger or a solar powered battery charger as is known to those skilled in the art, whereby the electrical energy stored in the battery can be replenished even while the battery is at the remote location of the container/waterer.

The housing is further configured and arranged so as to be capable of withstand mechanical loadings that could be imposed on the housing during use, such as by a domesticated animal (e.g., dog, cat), livestock (e.g., horse) or wild animal (e.g., wild birds). In exemplary embodiments, the housing further includes a contact preventing mechanism to prevent a user or an animal from coming into physical contact with a hottest portion of the housing when the heating device is immersed in the fluid/water.

In an illustrative embodiment, the contact preventing mechanism comprises a plurality, more specifically a multiplicity, of vanes, fins or ribs disposed about and extending from an exterior surface of the housing. The plurality/multiplicity of vanes, fins or ribs are configured and arranged so that a temperature of an end portion of each, proximal the hottest portion of the housing, is less than a predetermined temperature. They also are arranged so as to extend along part of the length of the housing, the full length of the housing, or to extend beyond the ends of the housing. In more particular embodiments, the vanes, fins or ribs are integrally formed with the member comprising the housing.

In an alternative embodiment, the contact preventing mechanism further includes an outer member secured to the vanes/fins/ribs and being configured and arranged so as to generally form an annular space between the housing exterior surface and an interior surface of the outer member. In an exemplary embodiment, the housing is a cylindrical member having sealed ends and the outer member is a generally tubular member.

Also featured is a fluid/water heating device as herein described in combination with a portable power supply as also herein described. Further featured is a remotely locatable drinking water system including any of the herein described fluid/water heating devices and any of the herein described portable power supplies.

Further featured is a method for supplying a source of liquid water to animals from a container, that includes providing a water heating device including a housing, being configured and arranged so as to be immersible in water; a heat generating mechanism that is disposed within the housing; and a mechanism for thermally coupling the heat generating mechanism and the housing so that at least some heat energy being generated by the heat generating mechanism is coupled to the housing. The method also includes immersing the provided water heating device into the container and electrically coupling the heat generating mechanism of the provided water heating device to a portable power supply so the heat generating mechanism generates the heat energy. The method further includes dissipating at least a portion of the heat energy being thermally coupled to the housing to the water in the container, and maintaining a liquid supply of at least a portion of the water within the container using the heat energy being dissipated.

Such a method of the present invention, further includes configuring and arranging each of the heat generating mechanism and the portable power supply so that the heat energy being dissipated during said dissipating is sufficient to maintain the liquid supply for a predetermined time. In an exemplary illustrative embodiment, the predetermined time is at least about 4 hours.

In specific embodiment and in regards to the provided water heating device, the heat generating mechanism is a resistive element having a resistivity in the range of from about 6 to 70 ohms more particularly in the range about 12 to 30 ohms and more specifically a resistivity of 18 or 27 ohms. Also, in regards to the power supply, the power supply is capable of providing a current output of a predetermined minimum value at a minimum ambient temperature for operation of the water heating device.

In yet other aspects of the present invention, the water heating device of the present invention is configured and arranged so that the power supply is disposed within the structure of the water heating device including those described herein. In more particular embodiments, the housing for the water heating device is configured and arranged so that the various elements of the power supply, including the power storage elements thereof, are disposed within the housing so that these power supply elements are electrically coupled to the heat generating mechanism within the housing. In this way, a waterproof or water resistant connection in the housing and waterproof or water resistant cabling need not be provided to electrically couple the heat generating mechanism to the portable power supply.

In more particular embodiments, the housing is further configured and arranged so that the power storage elements of the power supply can be removed from the housing so that new or refreshed power storage elements can be inserted into the housing. In more particular embodiments, the portable storage elements include, but are not limited to rechargeable or non-rechargeable storage devices (e.g., rechargeable or non-rechargeable batteries, capacitors, etc.). In an illustrative embodiment, the housing is formed from two portions that are threadably secured to each other and embodying any of a number of mechanisms known to those skilled in the art so as to form a water resistant or waterproof seal between the two housing portions when so secured to each other. In yet further particular embodiments, the housing is further configured and arranged so a that the power storage elements of the power supply are located distal from the heat generating mechanism so that the portion of the housing containing the power storage elements is disposed outside of or above the water.

Other aspects and embodiments of the invention are discussed below.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1A is a schematic circuit block diagram of a watering vessel heating apparatus according to one aspect of the present invention;

FIG. 1B is a schematic circuit block diagram of a watering vessel heating apparatus according to another aspect of the present invention;

FIG. 2 is a perspective view of one embodiment of a watering vessel heater according to a first aspect of the present invention;

FIG. 3 is a front end view of the watering vessel heater of FIG. 2;

FIG. 4 is a section view of the watering vessel heater of FIG. 2 taken along section line 4-4 of FIG. 3;

FIG. 5 is an end view of another embodiment of a watering vessel heater according to a first aspect of the present invention;

FIG. 6 is a section view of the watering vessel heater of FIG. 5 taken along section line 6-6;

FIG. 7 is a perspective view of the watering vessel heater of FIG. 5 viewing the end from which the interconnecting wire exits;

FIG. 8 is an exploded side view of the watering vessel heater of FIG. 5;

FIGS. 9-10 are various views of a watering vessel heater according to a second embodiment of the present invention;

FIG. 11 is a partial cross-section view of a watering vessel heater according to a third embodiment of the present invention;

FIG. 12 is an exemplary side view of a portion of a watering vessel, such as a bird bath, illustrating further embodiments and one technique for locating a watering vessel heater according to the present invention in such a vessel;

FIGS. 13A,B are an illustrative views of a pail generally illustrating another technique for locating one or more watering vessel heaters in such a pail;

FIG. 14 is an illustrative view of a water warmer/heater according to another aspect of the present invention in a watering dish;

FIGS. 15A,B are illustrative views of a water warmer/heater of FIG. 14 further including a mechanism for restraining movement of the water warmer/heater; and

FIGS. 16A,B are cross-sectional views of the water warmer/heater of FIG. 14 without the power supply (FIG. 16A) and with a power supply (FIG. 16B).

### DESCRIPTION OF THE PREFERRED EMBODIMENT

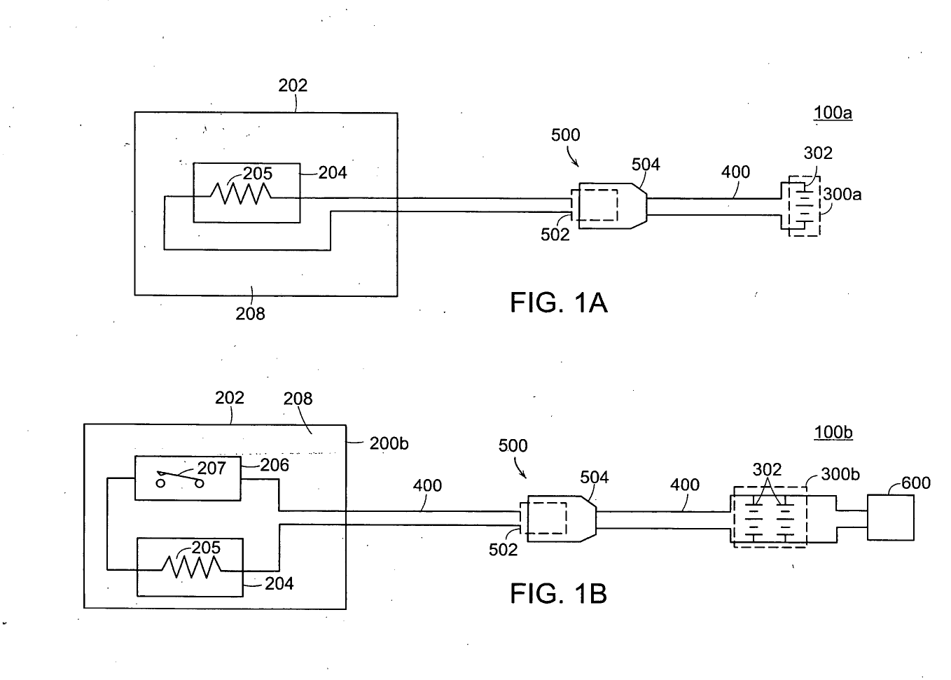

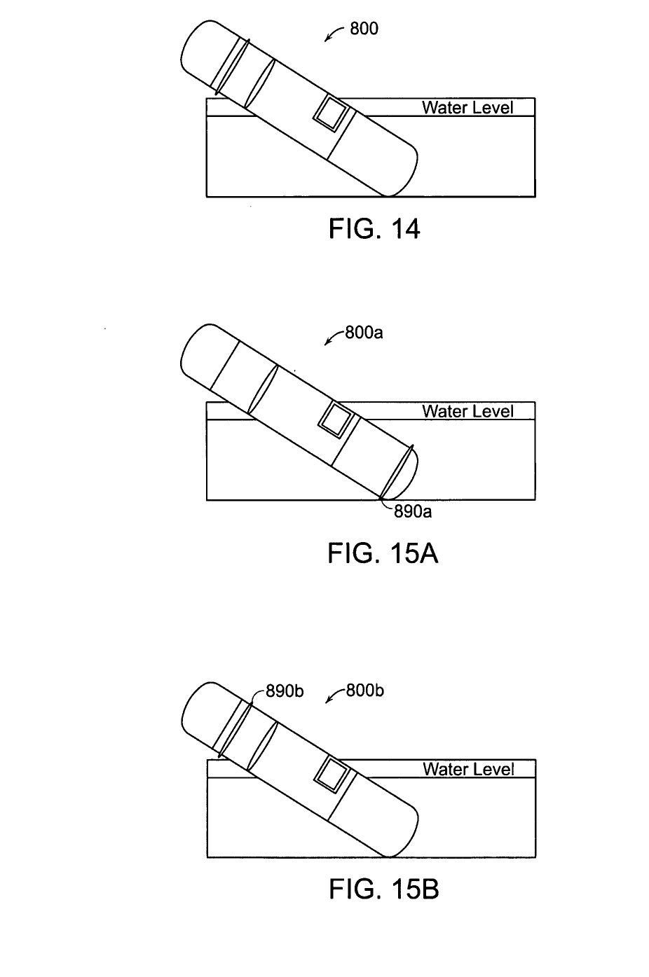

Referring now to the various figures of the drawing wherein like reference characters refer to like parts, there is shown in FIG. 1A, B schematic circuit block diagrams of watering vessel heating apparatuses 100a,b according to the present invention. Each of which include a watering vessel heater 200 and a portable power supply 300. In the following discussion reference numerals without alpha characters (e.g., 100) shall be used to generally identify an apparatus, device or element of the present invention, however, the reference numeral shall further include an alpha character (e.g., 100a) when referring to specific embodiments or aspects of such apparatus, device or element of the present invention. As discussed below regarding FIGS. 14-16, a watering vessel heating apparatus of the present invention also is capable of being arranged so that the portable power supply and the water vessel heater are disposed within a common structure.

The watering vessel heating apparatus 100 of the present invention is generally configured and arranged so as to keep at least a portion of the water in a watering vessel in a liquid form during those times of the year (e.g., winter months) when ambient temperatures (e.g., ambient air temperature) are at or below the freezing temperature for water. Such a watering vessel heating apparatus 100 also is generally configured and arranged to provide such heating capability at locations remote from a household or a building electrical power distribution network (e.g., 110v AC electrical outlets). Further, a watering vessel heating apparatus 100 according to the present invention is adaptable to provide such a water heating capability for different watering vessels for a wide range of animals including livestock such as horses, wild animals such as birds and pets such as dogs. In addition, a watering vessel heating apparatus according to the present invention generates such heat energy in such a way so as to avoid injury or harm (i.e., burning, electrical shock) to animals drinking from the watering vessel

Referring now to FIG. 1A, there is shown a schematic circuit block diagram of a watering vessel heating apparatus 100a according to one aspect of the present invention that includes a watering vessel heater 200a and a portable power supply 300a. The watering vessel heater 200a and the portable power supply 300a are operably and electrical coupled to each by interconnecting wiring 400. In an illustrative, exemplary embodiment, the interconnecting wiring 400 also includes a coupling connection 500 to selectively couple and de-couple the watering vessel heater 200a and the portable power supply 300a.

The portable power supply 300a is any of a number of portable electrical power sources known to those skilled in the art, particularly portable battery power sources and more particularly portable battery power sources that are capable of being recharged. In particular embodiments, the portable power supply 300a has a nominal output voltage in the range of from between 12 to 15 volts DC (VDC) and a capacity sufficient to maintain the desired quantity of water in a liquid form under specified ambient conditions. Further the portable power supply 300a comprises one or more batteries 302 (e.g., see also FIG. 1B), preferably rechargeable batteries, electrical arranged to provide a voltage and current capacity sufficient to maintain the operable heating characteristics of the watering vessel heater 200a for a desired period of time under specified ambient conditions (e.g., at or above 10° F.). As illustration, such capacities for power supplies including a lead acid battery having an output voltage in the range of 12-15 VDC, include any of 4 Amp-Hr. (AH), 7 AH and 17 AH. In an illustrative, exemplary embodiment, the portable power supply 300a comprises a rechargeable lead acid battery having an output voltage in the range of 12-15 volts and a capacity of 4 AH such as the RPB 1240 manufactured by Lectro Science, Inc.

Although a lead acid battery has been described above, other battery types are contemplated for use with the watering vessel heating apparatus 100 of the present invention. Such other battery types include, but are not limited to Nickel Cadmium (NiCd), Nickel Metal Hydride (NiMH), and generally types of batteries or portable power sources (e.g., Solar panel) known to those skilled in the art that exhibit or have a voltage-current characteristic that maintains the operable heating characteristics of the watering vessel heater 200a over the desired operating temperature range. In an exemplary, illustrative embodiment, such batteries or power sources are preferably capable of providing a current output of about ½ ampere at the desired minimum operating temperature, for example a temperature of about 10° F.

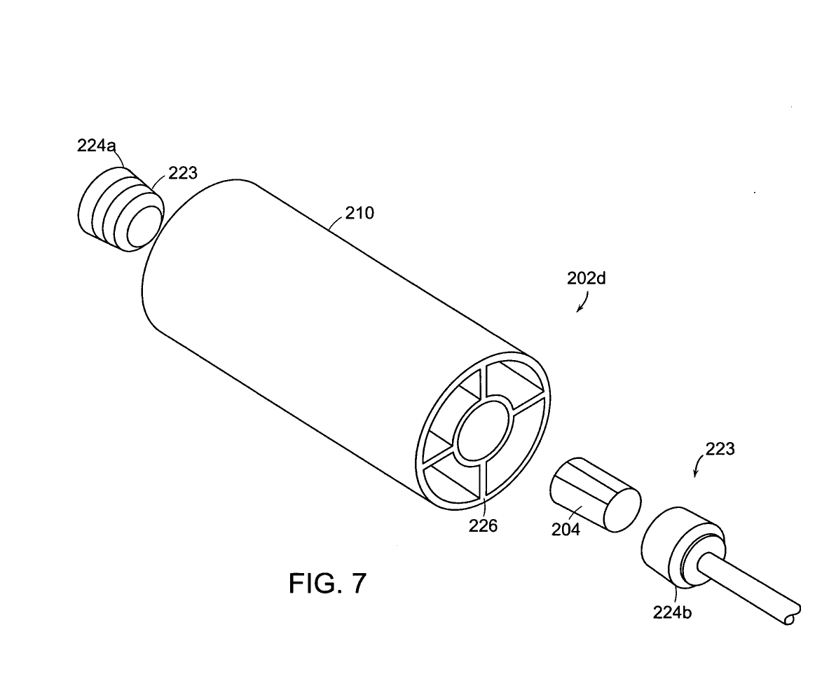

The watering vessel heater 200a includes a housing 202 and at least one heating element 204 disposed within the housing. The housing 202 provides a protective enclosure to protect the heating element from potential degrading environmental conditions and the animals drinking from the watering vessel. Also, the housing 202 provides a protective enclosure for the animals to prevent the animals from coming into direct contact with the heating element 204 when it is in operation. The housing 202 is further constructed, at least in part, of materials that allow the heat energy being developed by the heating element 204 to be conducted to the water surrounding the housing. In more specific embodiments, a material 208 is disposed within the housing to localize and secure the heating element 204 within the housing. Such materials are more fully described in the following discussion regarding FIGS. 3-11.

The heating element 204 is any of a number of devices or functionalities known in the art that generate heat energy from electrical energy. In an exemplary embodiment, the heating element 204 is a resistive heating element 205. More particularly, the resisitive-heating element 205 is a resistor having a resistivity in the range of from about 6 ohms to about 70 ohms, more particularly in the range of from about 12 ohms to about 30 ohms and more specifically about one of 18 ohms or 27 ohms. The resistivity of the resistive heating element 205 is generally established based on a balancing of such considerations as the amount of water to be maintained in a liquid form, minimum and normal ambient temperatures for heater operation, the available electrical energy from the portable power supply and maximum operating temperature of the housing. It also is desirable for such a resistive heating element 205 to exhibit a resistance to degradation due to moisture. In a more specific illustrative embodiment, the resistive heating element 205 is a 27 ohm, 5 watt wirewound resistor such as that manufactured by Yageo.

As illustration of heating capabilities of a watering vessel heater 200a including a resistive heating element 205, being a 18 ohm, 5 watt wirewound resistor and a portable power supply 300a having an output voltage between 12 to 15 VDC, and the watering vessel having a fluid capacity of about 1 quart; the watering vessel heater 200a will maintain a liquid supply of water above the center of the heater for up to about 4¼ hours when the ambient temperature is about 10-15° F. Such a portable power supply 300a is more particularly characterized as a rechargeable lead acid battery having an output voltage in the range of 12-15 volts and having a capacity of 4 AH.

Such a watering vessel heater 200a and portable power supply 300a combination also are capable of providing clear areas of liquid water in larger size containers. For example, such a combination will maintain an open area above the center of the unit in a gallon container for about 4½ hours and in a five gallon container, such as those used for horses, for about 5¾ hours. By increasing the capacity of the portable power supply 300 and/or by insulating the container or vessel, such operating times can be increased, in particular for the larger size containers. For example, if a battery having a capacity of 7 AH is utilized, a liquid supply of water can be maintained in one quart container for about 8½ hours. Further, a heater/power supply combination of the present invention also is set so that the surface temperature of the housing will not lead to or cause burning or such other harm or injury to a person handling or coming into contact with the watering vessel heater 200a as well as to an animal coming into contact with the watering vessel heater.

A watering vessel heater 200 according to the present invention is particularly advantageous for use in combination with a solar heated bird watering vessel, such as that described in U.S. Pat. No. 5,002,017, the teachings of which are incorporated herein by reference. These solar heating capabilities in combination with the watering vessel heater 200 of the present invention provides a mechanism by which a supply of liquid water can be made available for consumption by the animal for a longer period of time than either watering vessel is capable of providing alone. For example such a solar heated bird watering vessel can maintain a liquid supply for about 5 hours using a 4 AH battery and for about 9.0 hours using a 7 AH battery.

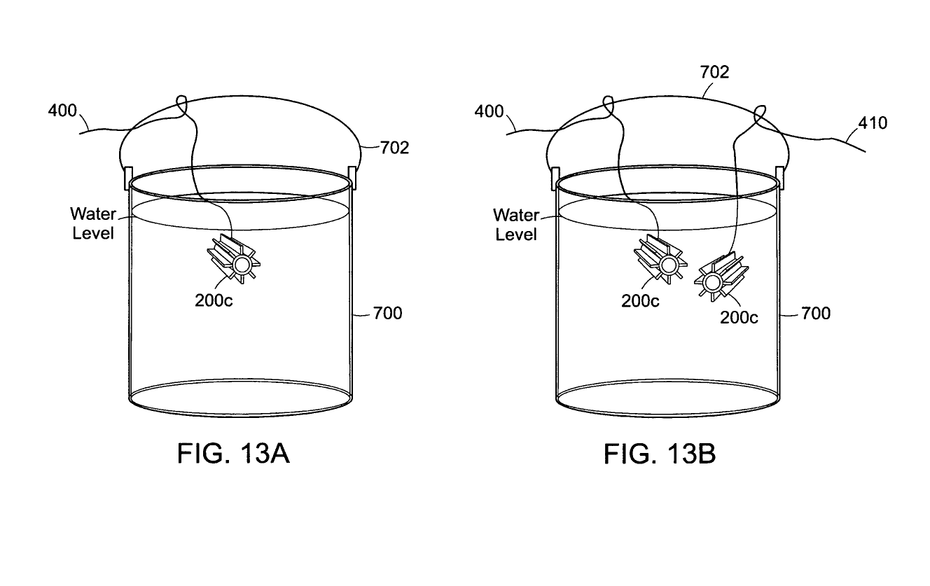

It should be recognized that in addition to increasing the heating capacity of the watering vessel heater 200a and or the energy capacity of the portable power supply 300a, as well as insulating the watering vessel to reduce heat loss to the surrounding environment, it also is within the scope of the present invention, for a watering vessel to be arranged with a plurality or more of watering vessel heating apparatuses. For example, a trough like watering vessel or a large can or pail like watering vessel (e.g., see FIG. 13B) can be arranged to include a plurality or a multiplicity of watering vessel heating apparatuses 100 so as to keep a plurality or more of open areas having liquid water available for drinking. It also is within the scope of the present invention for the individual portable power supplies to be aggregated or coupled together electrically so there is a single portable power supply feeding a group or all of the watering vessel heaters of a given watering vessel.

The interconnecting wire 400 that interconnects the watering vessel heater 200a and the portable power supply 300a is any of a number of wires or types of wires known to those skilled in the art that are appropriate for the environmental conditions, the electrical (i.e., voltage/current) requirements and which satisfy any applicable local building codes and regulations. In an illustrative embodiment, the interconnecting wire 400 is 18 AWG. As also indicated above, the interconnecting wire 400 includes a coupling assembly 500 including male and female ends 502, 504 of a well known cigarette plug assembly. In illustration, the male end 502 of the cigarette assembly is that manufactured by Memory Protection Devices and may further include an in-line fuse for over-current protection. The female end 504 typically is one of the end connection details provided with commercially available portable battery packs, such as those contemplated for use with the present invention.

Now referring to FIG. 1B, there is shown a schematic circuit block diagram of watering vessel heating apparatus 100a according to a second aspect of the present invention including a watering vessel heater 200b and a portable power supply 300b. The watering vessel heater 200b and the portable power supply 300b are operably and electrical coupled to each other by the interconnecting wiring 400. In an illustrative, exemplary embodiment, the interconnecting wiring 400 also includes a coupling connection 500 to selectively couple and de-couple the watering vessel heater 200b and the portable power supply 300b. Reference shall be made to the foregoing discussion regarding FIG. 1A for details of common or corresponding components, elements or functionalities not otherwise described and discussed below.

The watering vessel heater 200b according to this aspect of the present invention includes a heating element 204 and a control mechanism 206 for selectively controlling the flow of electricity through the heating element 204, more particularly selectively controlling flow responsive to temperature. In an exemplary embodiment the control mechanism comprises a temperature switch 207 that selectively turns the flow of electricity on and off so as to maintain the surface temperature of the housing 202 at or below a preset value. In more specific embodiments, such a temperature switch also is configurable to maintain the housing temperature at or below a preset value so the water temperature does not exceed a preset value. In an illustrative exemplary embodiment, the temperature switch 207 is a magnetic reed switch such as that manufactured by Thermodisc, Model No. MTS15B.

In the illustrated embodiment, the portable power supply 300b includes two batteries 302, which illustrates one mechanism for increasing the electrical energy capacity of the portable power supply in addition to proving a battery having a larger electrical power capacity. The illustrated watering vessel heating apparatus 100b also includes a charging mechanism 600 that is operably and electrical connected or coupled to the portable power supply 300b, more particularly to the one or batteries 302 comprising the portable power supply. The charging mechanism 600 is any of a number of mechanisms, devices or apparatuses known to those skilled in the art that can selectively charge the type of battery or batteries making up the portable power supply 300b. The charging mechanism 600 further includes a solar cell or photovoltaic cell array, as is known in the art, whereby sunlight is converted into electrical energy for charging. The charging mechanism 600 also can be configured and arranged so as to provide or supply a trickle charger or a small current or trickle current for charging the portable power supply 300b when the water vessel heater 200b is or is not operating.

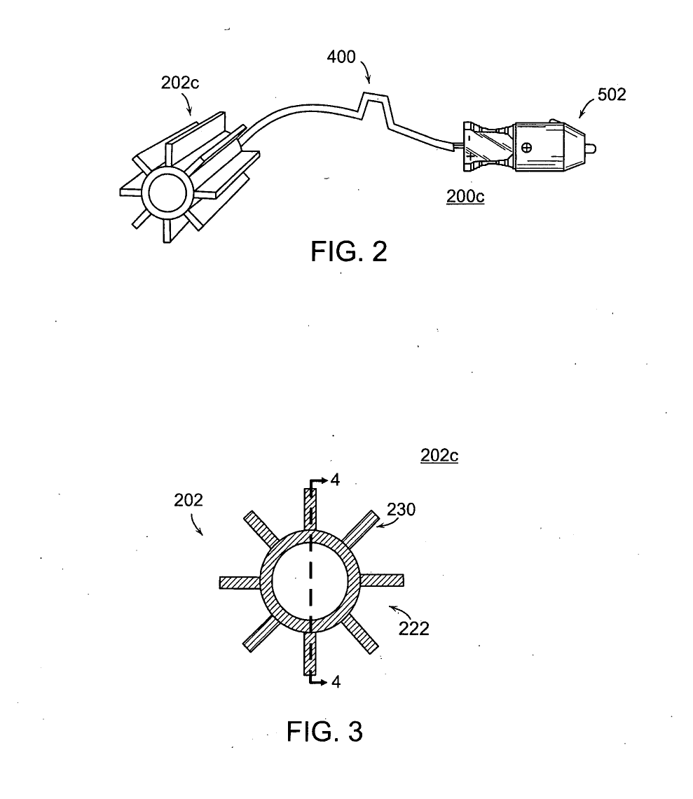

Now referring to FIGS. 2-5 there are shown various views of one embodiment of a watering vessel heater 200c according to the first aspect of the present invention. Reference shall be made to the foregoing discussion for FIGS. 1A,B for mechanisms, devices, elements or capabilities not other wise discussed in the following. The watering vessel heater 200c includes a housing 202c having an inner housing member 220 and housing ribs 230. The inner housing member 220 and the housing ribs 230 are made of a material including plastics such as low-density polyethylene (LDPE), ABS, metals and other materials known to those skilled in the art that yields a structure having sufficient rigidity for the intended application and capable of withstanding environmental conditions with little degradation to structural capability. The inner housing member 220 also is made of a material having generally good heat transfer capabilities so the heat energy developed within the inner housing member is readily transferred to the medium, solid or fluid, surrounding the watering vessel heater 200c. Preferably, such material also is used for the housing ribs 230, however, the present invention shall not be particularly limited to this limitation of materials. It should be recognized that is within the scope of the present invention for the watering vessel heater 200c to be initially disposed in a liquid medium or a solid medium such as ice crystals or a block of ice and for such a watering vessel heater to be capable of melting at least some of the surrounding solid medium into a liquid form.

The inner housing member 220 is generally sized and configured so as to provide a surface area that is sufficient for effective transfer of the heat energy being developed by the heating element 204 disposed therein to the medium. Further, the number, spacing, sizing and configuration of the housing ribs 230 is set so as to prevent direct contact of the inner housing member 220 by a user or caretaker while handling the housing 200c, more particularly from directly contacting those portions of the inner housing member proximal the heating element 204. Such configuring also assures that the drinking animal should not contact a hottest portion of the inner housing member 220.

The inner housing member 220 comprises a cylindrical hollow member 226 and end plugs 224a,b for sealing the open ends of the cylindrical hollow member. The end plugs 224a,b are sized and configured so an extended portion 223 thereof is received within an end of the cylindrical hollow member 226 and at least frictionally engages an inner surface 228 of the cylindrical hollow member 226. It is within the scope of the present invention for an opposing surface(s) of the extended portion 223 to include surface artifacts, such as radial extending circumferential ridges or radial protrusions, to form the mechanism for frictionally securing. Further, the extended portion 223 of the end plugs 224a,b can be secured to the hollow member inner surface 228 using any of a number of techniques known to those skilled in the art including adhesives welding such as vibrational welding of plastics, soldering and brazing that is appropriate for the materials making up the end plugs and the hollow cylindrical member 226.

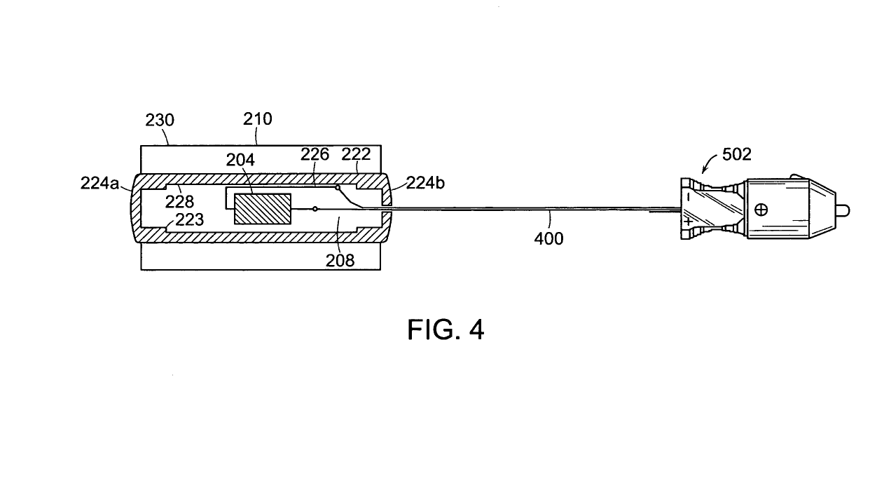

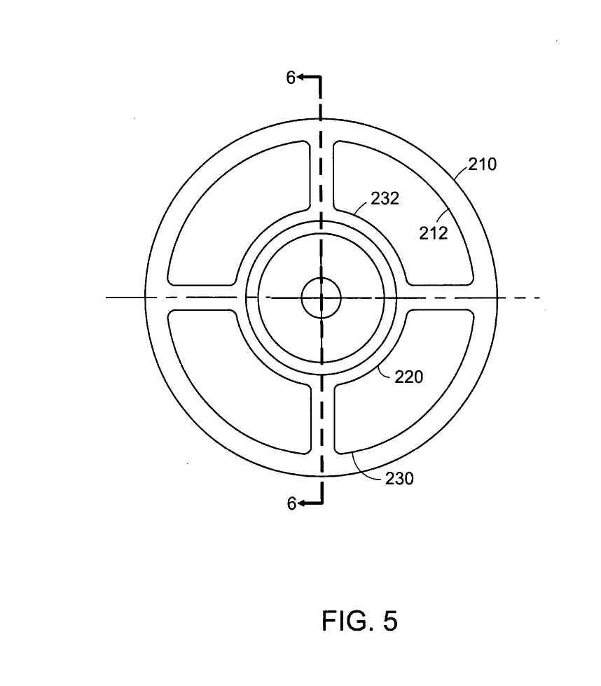

One end plug 224b is further configured so the interconnecting wire 400 can pass therethrough. Preferably, a material is disposed within the aperture in the one end plug 224b through which the interconnecting wire 400 passes so as to form a fluid barrier to prevent the influx of fluid into the interior volume formed and defined by the cylindrical hollow member 226 and the end plugs. Such material can be the same as the material 208 disposed within the interior volume of the inner housing member 210. As shown in FIGS. 2 and 4, the interconnecting wire 400, after passing through the one end cap 224b can be interconnected to a male plug 502, for example the male plug of a conventional cigarette connection assembly, and thereby electrically couple the heating element 204 to a power supply 300 according to the present invention.

Although the inner housing member 220 is shown as including a cylindrically shaped hollow member 226, the inner housing member is not particularly limited to the general shape and geometric configuration illustrated. It is within the scope of the present invention for the inner housing member 220 to have any of a number of geometric shapes and configurations known to those skilled in the art, including polygonal shapes, that are adaptable for use in dissipating or transferring heat energy therefrom to the surrounding medium.

As shown more clearly in FIG. 4, the heating element 204 is disposed in the interior volume formed and defined by the cylindrical hollow member 226 and the end plugs 224a,b. In addition, a material 208 is disposed in this volume to localize and secure the heating element 204 within the cylindrical hollow member 226 and thus within the inner housing member 220. Such a material 208 also has a heat transfer capability or characteristic such that the heat energy generated by the heating element 204 is transferred from the heating element via the material to the cylindrical hollow member 226 and/or the end plugs 224a,b and thence to the surrounding medium (e.g., water). In particular embodiments, the material 208 is a potting material or potting cement as is known to those skilled in the art, which exhibits good heat transfer characteristics. In an exemplary illustrative embodiment, the material 208 is a potting cement such as Zircon potting cement #13 as manufactured by Sauereisen, Inc.

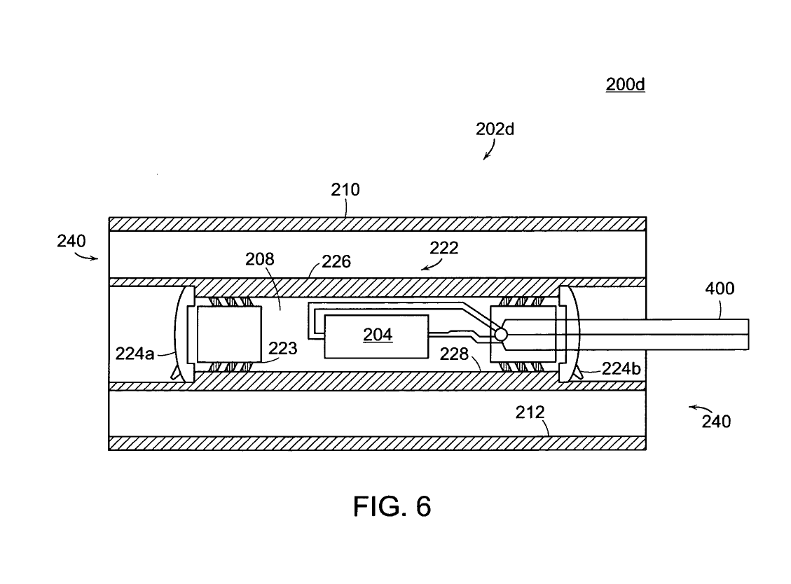

Now referring to FIGS. 6-8, there are shown various views of another embodiment of a watering vessel heater 200d according to the first aspect of the present invention. Reference shall be made to the foregoing discussion for FIGS. 1-5 for mechanisms, devices, elements or capabilities not otherwise discussed in the following.

In this embodiment, the housing 202c includes an outer housing member 210 and an inner housing member 220 that is spaced from the outer housing member by the housing ribs 230. The outer housing member 210 is made of a material including plastics such as LDPE, ABS, metals and other material known to those skilled in the art that in combination with the materials of the inner housing member 220 and the housing ribs 230 yields a structure having sufficient rigidity for the intended application and capable of withstanding environmental conditions with little degradation to structural integrity. Preferably, the outer and inner housing members 210, 220 and the housing ribs 230 are made of the same material, however, the present invention shall not be particularly limited to this limitation of materials.

In an exemplary embodiment, the housing ribs 230 are configured and arranged so as to maintain the inner surface 212 of the outer housing member 210 in spaced relation from the outer surface 222 of the inner housing member 220. Such housing ribs 230 also provide a mechanism for limiting the transfer of available heat energy to the outer housing member 210, thereby also limiting the operating temperature of the outer surface of the outer housing member. In an illustrative embodiment, the housing ribs 230 also extend axially along the length of the outer housing member 210 although the length is not so particularly limited.

The housing ribs 230 and the outer and inner members 210, 220 also are configured and arranged so that at least one end 240 and preferably both ends of the housing 202c are open and so as to form a volume between the outer and inner housing members that communicates with the open end(s) of the housing. In this way, the liquid or solid medium that is disposed in the volume between the outer and inner housing members 220, 230 receives the heat energy being generated within the inner housing member. Such inter-disposition of the liquid or solid medium also provides a mechanism for limiting the amount of heat energy that can reach the outer housing member 210 and thus limits the temperature of the outer housing member.

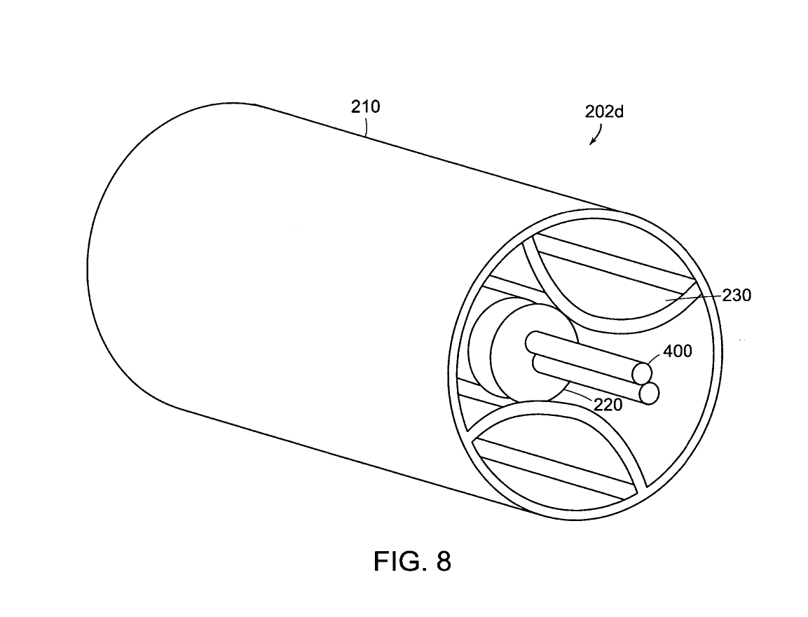

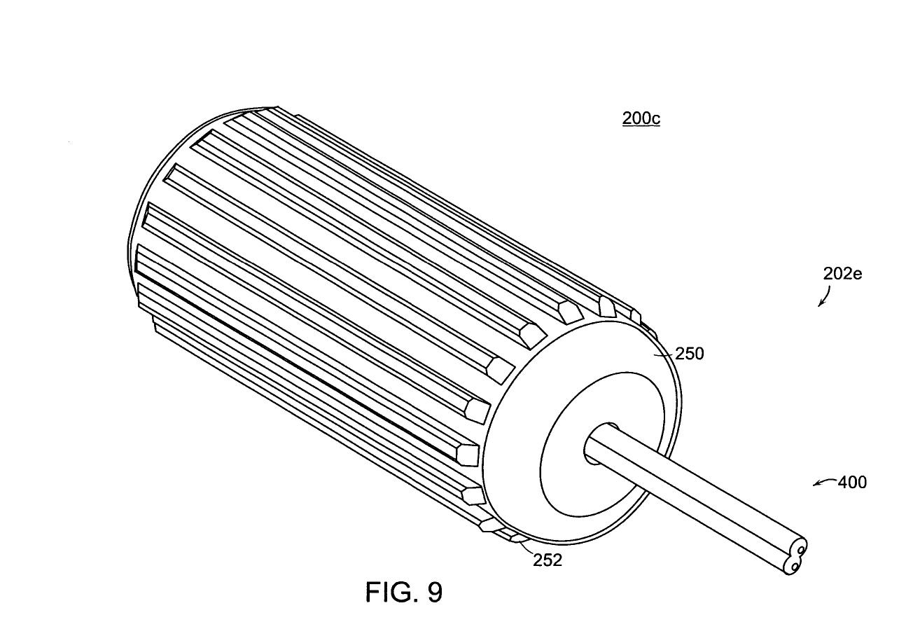

In a more specific illustrative embodiment, and as shown in FIG. 8, the lengths of the inner and outer housing members 210, 220 are set so the ends of the inner housing member are disposed within the outer housing member 210 and set back from the ends of the outer housing member. As also shown in FIG. 8, the housing ribs 230 can extend within and along the length of the outer housing member 210 beyond the length of the inner housing member 220 so as to provide a further mechanism to avoid inadvertent contact with the inner housing member 220 via the open ends of the outer housing member 210.

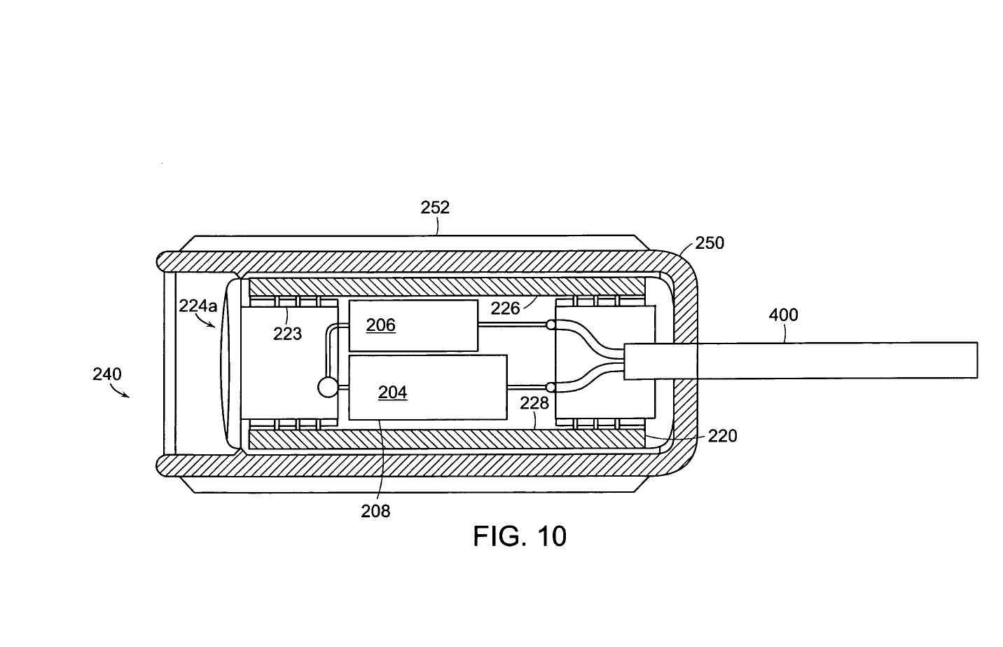

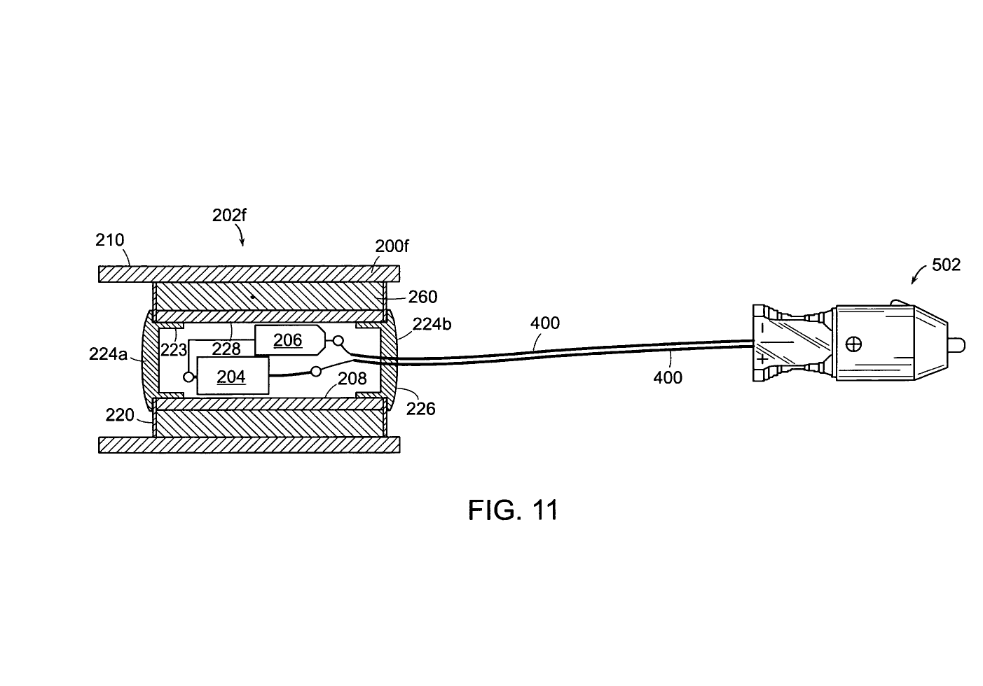

Now referring to FIGS. 9-10, there are shown a perspective view and a cross-section side view, respectively, of a watering vessel heater 200e according to an embodiment of the second aspect of the present invention. Reference shall be made to the foregoing discussion for FIGS. 1-8 for mechanisms, devices, elements or capabilities not otherwise discussed in the following.

The watering vessel heater 200e includes a housing 202e having an inner housing member 220 and a covering member 250. The covering member 250 is configured and arranged so as to cover the inner housing member 220 so as to essentially enclose one end of the inner housing member and to extend axially and circumferentially about the inner housing member leaving one end 240 open, the end of the inner housing member being sealed by the plug 224a.

The inner housing member 220 is made of a material including plastics such as low-density polyethylene (LDPE), ABS, metals and other materials known to those skilled in the art that yields a structure having sufficient rigidity for the intended application and capable of withstanding environmental conditions with little degradation to structural capability. The inner housing member 220 also is made of a material having generally good heat transfer capabilities so the heat energy developed within the inner housing member is readily transferred to the medium, solid or fluid, surrounding the watering vessel heater 200e. In an exemplary embodiment, the covering member 250 is made of the same material as the inner housing member 220. Alternatively, the cover member 250 is made of a silicone rubber type of material so as to limit the surface temperature of the cover member to less than a predetermined value.

In an illustrative embodiment, the cover member 250 further includes a plurality, more specifically a multiplicity of fins or ribs 252. The number, spacing, sizing and configuration of such ribs 252 is set so as to prevent direct contact of the exterior cylindrical surface of the cover member 250 by a user or caretaker while handling the housing 200e, more particularly from directly contacting those portions of the cover member proximal the heating element 204. Such configuring also assures that the drinking animal should not contact a hottest portion of thereof.

The inner housing member 220 comprises a cylindrical hollow member 226 with an end plug 224a for sealing one of the open ends of the cylindrical hollow member. As indicated above, the cover member essentially seals the other open end of the cylindrical hollow member. The end plug 224a is sized and configured so an extended portion 223 thereof is received within an end of the cylindrical hollow member 226 and at least frictionally engages an inner surface 228 of the cylindrical hollow member 226. It is within the scope of the present invention for an opposing surface(s) of the extended portion 223 to include surface artifacts, such as radial extending circumferential ridges or radial protrusions, to form the mechanism for frictionally securing. Further, the extended portion 223 of the end plug 224a can be secured to the hollow member inner surface 228 using any of a number of techniques known to those skilled in the art including adhesives welding such as vibrational welding of plastics, soldering and brazing that is appropriate for the materials making up the end plugs and the hollow cylindrical member 226.

A portion of the cover member 250 is further configured so the interconnecting wire 400 can pass therethrough. Preferably, a material is disposed within the aperture through which the interconnecting wire 400 passes so as to form a fluid barrier to prevent the influx of fluid into the interior volume formed and defined by the cylindrical hollow member 226 and the end plug and the cover member 250. Such material can be the same as the material 208 disposed within the interior volume of the inner housing member 220.

As shown more clearly in FIG. 10, the heating element 204 and the control mechanism 206 are disposed in the interior volume formed and defined by the cylindrical hollow member 226, the end plug 224a and the cover member 250. In addition, a material 208 is disposed in this volume to localize and secure the heating element 204 and the control mechanism 206 within the cylindrical hollow member 226 and thus within the inner housing member 220. Such a material 208 also has a heat transfer capability or characteristic such that the heat energy generated by the heating element 204 is transferred from the heating element to the surrounding medium (e.g., water).

Now referring to FIG. 11 there is shown a partial cross-section view of a watering vessel heater 200f according to another embodiment of the second aspect of the present invention. Reference shall be made to the foregoing discussion for FIGS. 1-10 for mechanisms, devices, elements or capabilities not other wise discussed in the following.

The watering vessel heater 200f includes a housing 202f having an outer housing member 210 and an inner housing member 220 that is spaced from the outer housing member by an intermediate member 260. In an exemplary embodiment, the intermediate member is composed of a material such as polyethylene or other material known to those skilled in the art that forms a thermal break between the outer and inner housing members 210, 220. Such a thermal break provides a mechanism to prevent direct contact of the inner housing member 220 by a user or caretaker while handling the housing 202f, more particularly from directly contacting those portions of the inner housing member proximal the heating element 204. Such configuring also assures that the drinking animal should not contact a hottest portion of the inner housing member 220.

The inner housing member 220 comprises a cylindrical hollow member 226 and end plugs 224a,b for sealing the open ends of the cylindrical hollow member. The end plugs 224a,b are sized and configured so an extended portion 223 thereof is received within an end of the cylindrical hollow member 226 and at least frictionally engages an inner surface 228 of the cylindrical hollow member 226.

One end plug 224b is further configured so the interconnecting wire 400 can pass therethrough. Preferably, a material is disposed within the aperture in the one end plug 224b through which the interconnecting wire 400 passes so as to form a fluid barrier to prevent the influx of fluid into the interior volume formed and defined by the cylindrical hollow member 226 and the end plugs. Such material can be the same as the material 208 disposed within the interior volume of the inner housing member 220. As also shown, the interconnecting wire 400, after passing through the one end cap 224b can be interconnected to a male plug 502, for example the male plug of a conventional cigarette connection assembly, and thereby electrically couple the heating element 204 to a power supply 300 according to the present invention.

Although the inner housing member 220 is shown as including a cylindrically shaped hollow member 226, the inner housing member is not particularly limited to the general shape and geometric configuration illustrated. It is within the scope of the present invention for the inner housing member 220 to have any of a number of geometric shapes and configurations known to those skilled in the art, including polygonal shapes, that are adaptable for use in dissipating or transferring heat energy therefrom to the surrounding medium.

The heating element 204 and the control mechanism 206 are disposed in the interior volume formed and defined by the cylindrical hollow member 226 and the end plugs 224a,b. In addition, a material 208 is disposed in this volume to localize and secure the heating element 204 and the control mechanism 206 within the cylindrical hollow member 226 and thus within the inner housing member 220. Such a material 208 also has a heat transfer capability or characteristic such that the heat energy generated by the heating element 204 is transferred from the heating element to the surrounding medium (e.g., water).

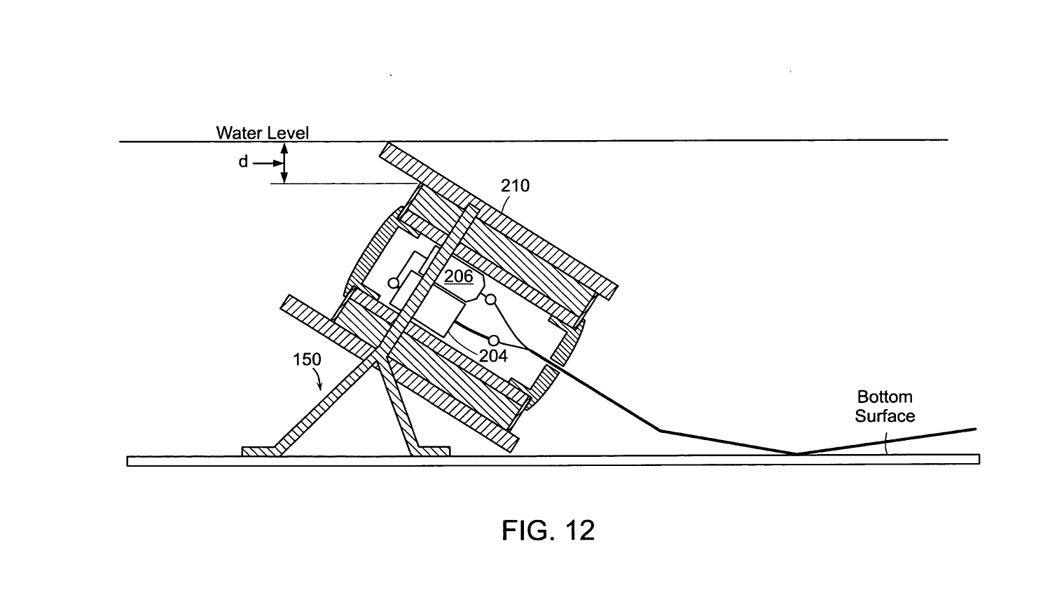

Now referring to FIG. 12 there is shown an exemplary side view of part of a watering vessel, such as a bird bath, that illustrates further embodiments and also illustrates a technique for locating a watering vessel heater 200 according to the present invention in such a vessel. Reference shall be made to the foregoing discussion for FIGS. 1-11 for mechanisms, devices, elements or capabilities not other wise discussed in the following. Although the watering vessel heater 200f of FIG. 11 is illustrated, it is contemplated and is within the scope of the present invention for any of the above-described watering vessel heaters 200a-e, as well as any other watering vessel heater as taught by the within application to be adapted and located in the manner as taught herein in FIG. 12.

In this embodiment, the watering heating apparatus 100 further includes a set of adjustable legs 150 that are secured to the outer housing member 210 so as a to support the watering vessel heater 200f off a bottom surface of the watering vessel. The legs are adjustable so that an open end of the watering vessel heater 200f is located a predetermined distance below the nominal level of the water in the watering vessel. Preferably the distance is set so that the watering vessel heater 200f is located to optimize the amount of water being maintained in a liquid form at minimal ambient temperatures while being at a depth sufficient for purposes of avoiding damage to the watering vessel heater while the animal is drinking from the watering vessel. In exemplary embodiments, the depth “d” is set so as to be in the range of from about 0.5 to about 2 inches below the nominal water level, more specifically the depth is set at about 1.5 inches below the nominal water level.

Now referring to FIGS. 13A,B there is shown exemplary illustrative views of a large pail container 700 that illustrates a technique for locating one (FIG. 13A) or more (FIG. 13B) watering vessel heaters 200c according to the present invention in such a vessel. Reference shall be made to the foregoing discussion for FIGS. 1-12 for mechanisms, devices, elements or capabilities not other wise discussed in the following. Although the watering vessel heater 200c as shown in FIGS. 2-4 is illustrated, it is contemplated and is within the scope of the present invention for any of the above-described watering vessel heaters 200a-f, as well as any other watering vessel heater as taught by the within application to be adapted and located in the manner as taught herein in FIGS. 13A,B.

In the illustrated embodiment, each of the watering vessel heaters 200c is suspended from the handle 702 of the pail container 700 so that the watering vessel heater 200c is located below the nominal level of the water in the pail container. Preferably, the watering vessel heater 200c is suspended in such a manner so that the depth below the nominal water level is adjustable. In the illustrated embodiment, a portion of the interconnecting wiring 400 is wrapped or looped about the handle 702 so as to suspend the watering vessel heater 200c although this is exemplary and shall not be considered particularly limiting.

Preferably, each watering vessel heater 200c is located a predetermined distance below the nominal level of the water in the watering vessel to optimize the amount of water being maintained in a liquid form at minimal ambient temperatures while being at a depth sufficient for purposes of avoiding damage to the watering vessel heater while the animal is drinking from the watering vessel. In exemplary embodiments, this depth is set so as to be in the range of from about 0.5 to about 2 inches below the nominal water level, more specifically the depth is set at about 1.5 inches below the nominal water level.

In the case where a plurality of watering vessel heaters 200c are disposed in a pail container 700, the watering vessel heaters 200c can be both located at the same depth in the range of from about 0.5 to about 2 inches below the nominal water level, more specifically about 1.5 inches below the nominal water level, or they each can be located at different depths in the range of from about 0.5 to about 2 inches below the nominal water level. Further, one watering vessel heater 200c can be located at a depth in the range of from about 0.5 to about 2 inches, more specifically 1.5 inches, below the nominal water level and the other of the watering vessel heater 200c can be located at a depth greater that 2 inches below the nominal water level.

Referring now to FIGS. 14-16 there is shown various views of a water warmer/heater 800 according to another aspect of the present invention. In the illustrated embodiment, the power supply 859 is disposed within the water warmer/heater 800; however, it is contemplated and thus within the scope of the present invention, for any of the above described water warmers/heaters to be configured so that the power supply is located within the structure defining the water warmer/heater. It also is contemplated and thus within the scope of the present invention, for the water warmer/heater illustrated in FIGS. 14-16 to be adapted for use with a power supply that is located remote from the warmer/heating elements of the invention as generally depicted in FIGS. 1-13 above.

As shown in FIGS. 14-15, in one embodiment of this aspect of the invention, the water/warmer heater 800 is disposed in the water such that the end of the water warmer/heater that outputs the heat energy is disposed in the water and so the other end of the water warmer/heater containing the power supply is generally disposed out of the water. However, this is not limiting as it is contemplated and thus within the scope of the present invention for the water warmer/heater to be completely disposed in the water.

In further embodiments, and with reference to FIGS. 15A,B the water warmer/heater 800 further includes a mechanism 890 that extends outwardly and beyond the housing 810 so as to create a stop or frictional surface that keeps the power supply end 824b of the housing out of the water. In one case as shown in FIG. 15A, the water/warmer heater 800a is configured so the movement restraining mechanism 890a is arranged so as to be proximal the heating end 824a of the water warmer/heater. In the illustrated embodiment, the movement restraining mechanism 890a mechanism interacts with a bottom surface of the fluid container to restrain movement. In another case as shown in FIG. 15B, the water/warmer heater 800a is configured so the movement restraining mechanism 890b is arranged so as to be proximal the power supply end 824b of the water warmer/heater. In the illustrated embodiment, the movement restraining mechanism 890b mechanism interacts with a side surface or edge of the fluid container to restrain movement.

In yet further embodiments and with reference also to that illustrated in FIGS. 13A,B; a securing member such as a rope, line or the like, is disposed about the housing proximal to the movement restraining mechanism 890b so that the securing member is thereby secured to the housing so as to restrain axial movement of the securing member with respect to the housing. Another portion of the securing member is secured to a handle 702 or other feature of the container 700 in which the water warmer/heater 800 is disposed so as to thereby secure the water warmer/heater with respect to the water level within the container. In further exemplary embodiments, the movement restraining mechanism 890a,b is a rubber material that can frictionally and/or mechanically engage with the fluid container.

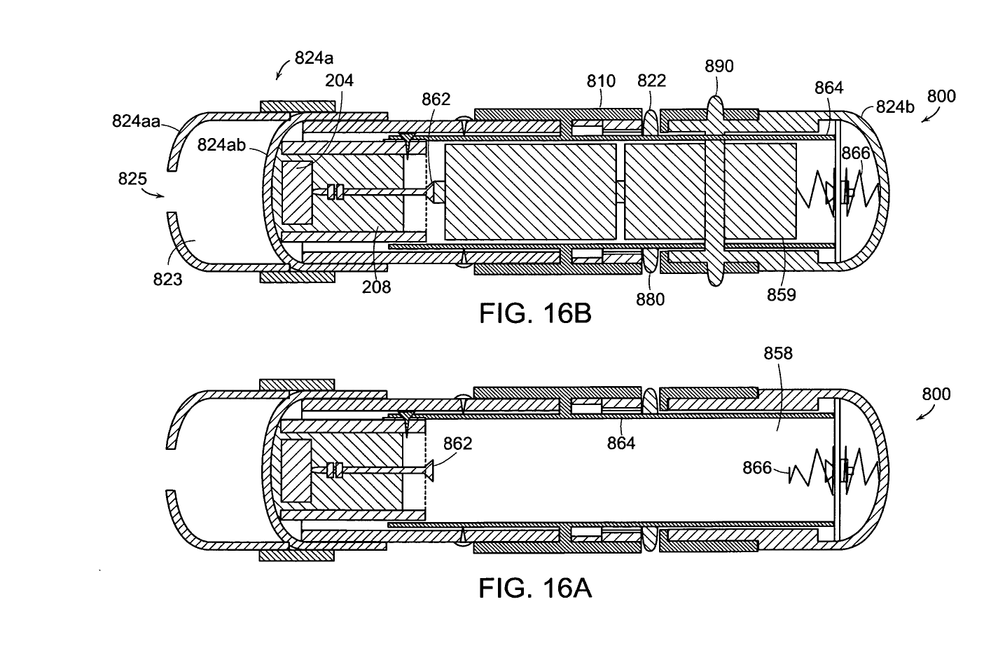

As more particular, shown in FIGS. 16A,B the water warmer/heater 800 includes a heating end 824a that is arranged with an inner end 824ab and an outer end 824aa. The outer and inner ends 824aa,ab are arranged so that they define a pocket 823 therebetween and so an aperture 825 in the outer pocket is fluidly coupled to the pocket.

Also the housing 810 of the water warmer/heater 800 is formed so as to include a power supply compartment 858 in which is received the power supply including the elements thereof. In further embodiments, the power supply includes one or more storage members 859 and electrical circuitry that electrical couples the power storage members to the resistor or heating element 204 disposed within the potting material 208. In this way, the electrical energy provided by the power storage members 859 is converted to heat energy by the resistor or heating element 204 and this energy is dispersed to the water via the potting material 208 that is thermally coupled to the heating end inner end 824ab as herein described. In the illustrated embodiment, the one or more power storage members include a plurality of batteries or cells 859 (e.g., D or C size rechargeable or non-rechargeable batteries) comprise the power supply.

In further particular embodiments, the electrical circuitry that electrical couples the that electrical couples the power storage members to the resistor or heating element 204 an electrical lead 862 includes first and second electrical leads 862,864 that appropriately couple the positive and negative terminals or sides of the one or more storage members 859 to the resistor or heating element 204. In illustrated exemplary embodiments, the first electrical lead 862 couples the positive terminal of the plurality of batteries to the to the resistor or heating element 204 and the second electrical lead 864 also couples the negative terminal of the plurality of batteries to the to the resistor or heating element 204 so that a voltage is applied across the resistor or heating element 204 and also so current flows there through.

In further illustrative embodiments, the electrical circuitry also includes a biasing element 866 that is electrically coupled to one of the electrical leads, the second electrical lead 864. The biasing element 866 also is arranged to act on one end (e.g., the negative end) of one of the one or more storage members 859 so as to urge the one or more storage members in such a fashion as to keep the other end (e.g., the positive end) of the storage member that is proximal the first electrical lead 862 in continuous contact with the first electrical lead. In illustrative embodiments, the biasing element 866 comprises a spring element that is supported from supporting structure coupled to the housing 810 so the spring is maintained in fixed relation to the housing 810. The spring/biasing element 866, the supporting structure or both is/are electrically coupled to the second electrical lead 864 using any of a number of techniques known to those skilled in the art.

In the illustrated embodiment, the housing 810 includes a combined coupling and sealing joint 880 that mechanically and sealing engages the heating and power supply ends 824a,b. In particular exemplary embodiments, opposing ends of the heating and power supply ends 824a,b of the housing 810 are configured to form a threaded connection therebetween so as to threadably and mechanically couple the two ends together. It should be recognized that when these ends are mechanically coupled to each other the power supply compartment 858 is formed within the housing.

Also, a sealing member 882, such as for example a rubber o-ring or rubber washer, is disposed between opposing surfaces of the opposing ends opposing ends of the heating and power supply ends 824a,b of the housing 810. Thus, when the opposing ends of the heating and power supply ends 824a,b of the housing 810 are threadably and mechanically coupled to each other, the sealing member 882 member sealingly engages the opposing ends so as to form a fluid seal between the heating and power supply ends 824a,b of the housing. The fluid seal formed therebetween is resistant to fluid that is on the exterior of the housing. It also is contemplated and is thus within the scope of the present invention, for the water warmer/heater 800 to be submerged within the water or fluid. As such, the joint 880 coupling and sealing the heating and power supply ends 824a,b of the housing joint 810 can be formed using any of a number of techniques know to those skilled in the art to prevent water from leaking into the power supply compartment or other areas within the housing when so submerged.

Although a preferred embodiment of the invention has been described using specific terms, such description is for illustrative purposes only, and it is to be understood that changes and variations may be made without departing from the spirit or scope of the following claims.

What is claimed is:

1. A fluid heating device comprising:
a housing;
a heat generating mechanism that is disposed within the housing and electrically coupled to a portable power supply;
a mechanism for thermally coupling the heat generating mechanism and the housing so that at least some of the generated heat energy is coupled to the housing;
wherein the housing is configured and arranged so as to be immersible in fluid within a container and so that at least a portion of the heat energy being thermally coupled to the housing is dissipated to the fluid; and
wherein the heat generating mechanism is configured and arranged so the heat energy being dissipated to the fluid is sufficient to maintain a liquid supply of a least a portion of the fluid within the container for a predetermined time.

2. The fluid heating device of claim 1, wherein the heat generating mechanism is a resistive element.

3. The fluid heating device of claim 2, wherein the resistive element has a resistivity in the range of from about 6 to 70 ohms.

4. The fluid heating device of claim 2, wherein the resistive element has a resistivity in the range of from about 12 to 30 ohms.

5. The fluid heating device of claim 2, wherein the resistive element has a resistivity of one of 18 ohms or 27 ohms.

6. The fluid heating device of claim 1, wherein the housing is further configured and arranged so as to withstand mechanical loadings that can be imposed on the housing during use.

7. The fluid heating device of claim 1, wherein the housing further includes a contact preventing mechanism to prevent a user from coming into physical contact with a hottest portion of the housing.

8. The fluid heating device of claim 7, wherein the contact preventing mechanism comprises a plurality of vanes disposed about and extending from an exterior surface of the housing.

9. The fluid heating device of claim 8, wherein the plurality of vanes are configured and arranged so that a temperature of an end portion of each vane proximal the hottest portion of the housing is less than a predetermined temperature.

10. The fluid heating device of claim 8 wherein the contact preventing mechanism further includes an outer member secured to the plurality of vanes and being configured and arranged so as to generally form an annular space between the housing exterior surface and an interior surface of the outer member.

11. The fluid heating device of claim 10, wherein the housing is a cylindrical member and the outer member is a generally tubular member.

12. The fluid heating device of claim 1, wherein the portable power supply is capable of providing a predetermined current output at a minimum ambient temperature for operation of the fluid heating device.

13. The fluid heating device of claim 12, wherein the minimum ambient temperature is 10° F. or higher.

14. The fluid heating device of claim 1, wherein the portable power supply is a battery having a nominal output voltage in the range of from about 12 to 15 VDC and a power capacity in the range of from about 4 AH to about 17 AH.

15. A fluid heating device in combination with a portable power supply comprising:
a housing;
a heat generating mechanism that is disposed within the housing and electrically coupled to the portable power supply;
a coupling mechanism for thermally coupling the heat generating mechanism and the housing so that at least some of the generated heat energy is coupled to the housing;
wherein the housing is configured and arranged so as to be immersible in fluid within a container and so that at least a portion of the heat energy being thermally coupled to the housing is dissipated to the fluid;
wherein the heat generating mechanism is configured and arranged so the heat energy being dissipated to the fluid is sufficient to maintain a liquid supply of a least a portion of the fluid within the container for a predetermined time; and
wherein the portable power supply is capable of providing a predetermined current output at a minimum ambient temperature for operation of the fluid generating device.

16. A method for supplying a source of liquid water to animals from a container, comprising the steps of:
providing a water heating device including
a housing being configured and arranged so as to be immersible in water,
a heat generating mechanism that is disposed within the housing, and
a coupling mechanism for thermally coupling the heat generating mechanism and the housing so that at least some heat energy being generated by the heat generating mechanism is coupled to the housing;
immersing the provided water heating device into the container;
electrically coupling the heat generating mechanism of the provided water heating device to a portable power supply so the heat generating mechanism generates the heat energy;
transmitting at least a portion of the heat energy being thermally coupled to the housing to the water in the container, and
maintaining a liquid supply of at least a portion of the water within the container using the heat energy being transmitted thereto.

17. The method for supplying a source of liquid water of claim 16, further comprising the step of configuring and arranging each of the heat generating mechanism and the portable power supply so that the heat energy being transmitted during said transmitting is sufficient to maintain the liquid supply for a predetermined time.

18. The method for supplying a source of liquid water of claim 17, wherein the predetermined time is at least 4 hours.

19. The method for supplying a source of liquid water of claim 17, wherein the heat generating mechanism is a resisitive element having a resisitivity that is one of in the range of from about 6 to 70 ohms, in the range of from about 12 to 30 ohms, 18 ohms or 27 ohms.

20. The method for supplying a source of liquid water of claim 17, wherein the power supply is capable of providing a current output of a predetermined minimum value at a minimum ambient temperature for operation of the water heating device.
